(19) United States
(12) Patent Application Publication
(10) Pub. No.: US 2025/0184838 A1
(43) Pub. Date: Jun. 5, 2025

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/048,261

(22) Filed: Feb. 7, 2025

Related U.S. Application Data
(63) Continuation of application No. PCT/JP2023/028754, filed on Aug. 7, 2023.
(60) Provisional application No. 63/395,940, filed on Aug. 8, 2022.

(51) Int. Cl. H04W 36/00; H04W 36/36

(52) U.S. Cl. CPC H04W 36/00725; H04W 36/0077; H04W 36/362

(57) ABSTRACT

A communication control method according to one aspect is a communication control method used in a cellular communication system. The communication control method includes transmitting, at a base station to a user equipment, a conditional reconfiguration including permission information representing whether connection by RACH-less handover is permitted per target cell.

### RELATED APPLICATIONS

The present application is a continuation based on PCT Application No. PCT/JP2023/028764, filed on Aug. 7, 2023, which claims the benefit of U.S. Provisional Patent Application No. 63/395,940 filed on Aug. 8, 2022. The content of which is incorporated by reference herein in their entirety.

### TECHNICAL FIELD

The present disclosure relates to a communication control method used in a cellular communication system.

### BACKGROUND

The Third Generation Partnership Project (3GPP) that is a standardization project of a cellular communication system has studied introduction of a new relay node referred to as an Integrated Access and Backhaul (IAB) node (see, for example, Non-Patent Document 1). One or more relay nodes are involved in communication between a base station and a user equipment and perform relay for this communication.

### CITATION LIST

### Non-Patent Literature

Non-Patent Document 1: 3GPP TS 38.300 V17.1.0 (2022-06)

### SUMMARY

A communication control method according to a first aspect is a communication control method used in a cellular communication system. The communication control method includes transmitting, at a base station to a user equipment, a conditional reconfiguration including permission information representing whether connection by RACH-less handover is permitted per target cell.

A communication control method according to a second aspect is a communication control method used in a cellular communication system. The communication control method includes transmitting, at a donor node to a user equipment subordinate to a mobile relay node, a conditional reconfiguration including an execution condition executed in receiving an execution indication. The communication control method includes transmitting, at the donor node to the mobile relay node, a transmission indication indicating transmission of the execution indication. The communication control method includes transmitting, at the mobile relay node to the user equipment, the execution indication in response to reception of the transmission indication.

A communication control method according to a third aspect is a communication control method used in a cellular communication system. The communication control method includes transmitting, at a donor node to a mobile relay node, a first message including a common configuration common to a plurality of user equipments subordinate to the mobile relay node. The communication control method includes transmitting, at the donor node to the mobile relay node, a second message including an individual configuration of each of the plurality of user equipments subordinate to the mobile relay node. The communication control method includes transmitting, at the mobile relay node to each of the plurality of user equipments, an RRC reconfiguration message including the common configuration and the individual configuration.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, Parent nodes, and Child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a User Equipment (UE) according to the embodiment.

FIG. 6 is a diagram illustrating an example of a protocol stack related to RRC connection and NAS connection of an IAB-MT.

FIG. 7 is a diagram illustrating an example of a protocol stack related to an F1-U protocol.

FIG. 8 is a diagram illustrating an example of the protocol stack related to the F1-C protocol.

FIG. 9 is a diagram illustrating an operation example according to a first embodiment.

FIG. 10 is a diagram illustrating another operation example according to the first embodiment.

FIG. 11 is a diagram illustrating an operation example of a solution 2 according to a second embodiment.

FIG. 12 is a diagram illustrating the operation example according to the second embodiment.

FIG. 13 is a diagram illustrating another operation example according to the second embodiment.

FIG. 14 is a diagram illustrating operation examples of group handover according to a third embodiment.

FIG. 15 is a diagram illustrating an operation example according to the third embodiment.

FIG. 16 is a diagram illustrating another operation example according to the third embodiment.

FIG. 17 is a diagram illustrating an example of traditional handover (upper part) and an example of a group reconfiguration (lower part).

FIG. 18 is a diagram illustrating a solution 1 for reduction of service interruption.

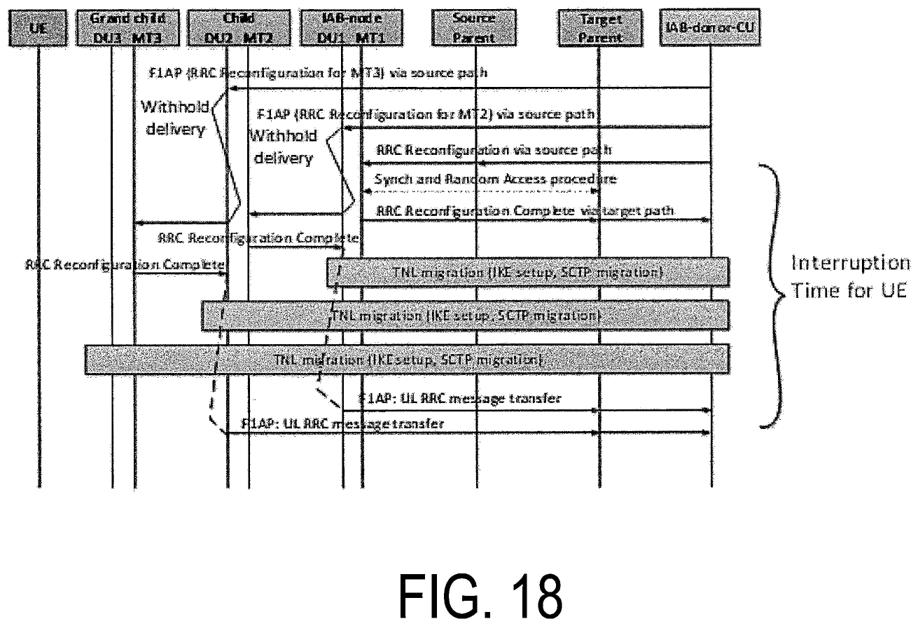

FIG. 19 illustrates the solution 2 for reduction of service interruption.

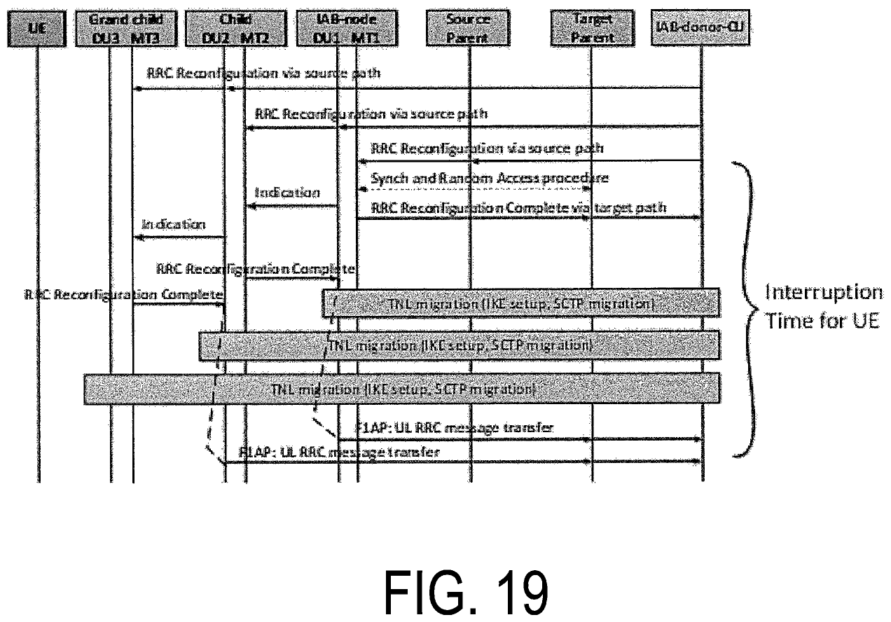

### DESCRIPTION OF EMBODIMENTS

A cellular communication system according to embodiments will be described with reference to the drawings. In the description of the drawings, the same or similar parts are denoted by the same or similar reference signs.

### First Embodiment

### Configuration of Cellular Communication System

A configuration example of the cellular communication system according to an embodiment will be described. A cellular communication system 1 according to the embodiment is a 3GPP 5G system. More specifically, a radio access scheme in the cellular communication system 1 is

New Radio (NR) that is a 5G radio access scheme. Note that Long Term Evolution (LTE) may be at least partially applied to the cellular communication system 1. A future cellular communication system such as 6G may be also applied to the cellular communication system 1.

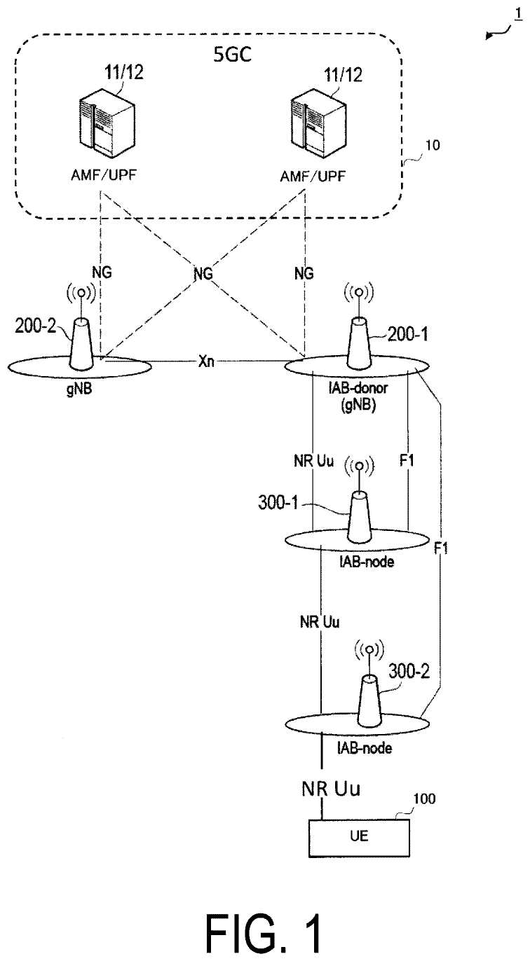

FIG. 1 is a diagram illustrating the configuration example of the cellular communication system 1 according to the embodiment.

As illustrated in FIG. 1, the cellular communication system 1 includes a 5G core network (5GC) 10, a User Equipment (UE) 100, base station devices (hereinafter, also referred to as “base stations” in some cases) 200-1 and 200-2, and IAB nodes 300-1 and 300-2. A base station 200 may be referred to as a gNB.

An example where the base station 200 is an NR base station will be mainly described below. However, the base station 200 may be an LTE base station (i.e., eNB).

Note that, in the following description, the base stations 200-1 and 200-2 may be referred to as the gNBs 200 (or base stations 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 is a device that performs various types of mobility controls and the like for the UE 100. The AMF 11 manages information of an area in which the UE 100 exists by communicating with the UE 100 by using Non-Access Stratum (NAS) signaling. The UPF 12 is a device that performs transfer control of user data and the like.

Each gNB 200 is a fixed wireless communication node and manages one or more cells. A cell is used as a term that indicates a minimum unit of a wireless communication area. The cell is also used as a term indicating a function or a resource for performing wireless communication with the UE 100. One cell belongs to one carrier frequency. Hereinafter, the cell and the base station may be used without distinction.

Each gNB 200 is interconnected to the 5GC 10 via an interface referred to as an NG interface. FIG. 1 illustrates the two gNB 200-1 and gNB 200-2 that are connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU, and includes an F1-C protocol that is a control plane protocol and an F1-U protocol that is a user plane protocol.

The cellular communication system 1 supports an IAB that enables wireless relay of the NR access using NR for the backhaul. The donor gNB 200-1 (or a donor node that hereinafter may be also referred to as a “donor node”) is a donor base station that is a terminal node of the NR backhaul on the network side and includes additional function of supporting the IAB. The backhaul can implement multi-hop via a plurality of hops (i.e., a plurality of the IAB nodes 300).

FIG. 1 illustrates an example where the IAB node 300-1 wirelessly connects to the donor node 200-1, the IAB node 300-2 wirelessly connects to the IAB node 300-1, and the F1 protocol is transmitted in two backhaul hops.

The UE 100 is a movable wireless communication device that performs wireless communication with the cells. The UE 100 may be any type of a device as long as the UE 100 is a device that performs wireless communication with the gNB 200 or the IAB node 300. For example, the UE 100 includes a mobile phone terminal and/or a tablet terminal, a notebook PC, a sensor or a device that is provided in a sensor, a vehicle or a device that is provided in a vehicle, and an aircraft or a device provided in an aircraft. The UE 100 wirelessly connects to the IAB node 300 or the gNB 200 via an access link. FIG. 1 illustrates an example where the UE 100 is wirelessly connected to the IAB node 300-2. The UE 100 indirectly communicates with the donor node 200-1 via the IAB node 300-2 and the IAB node 300-1.

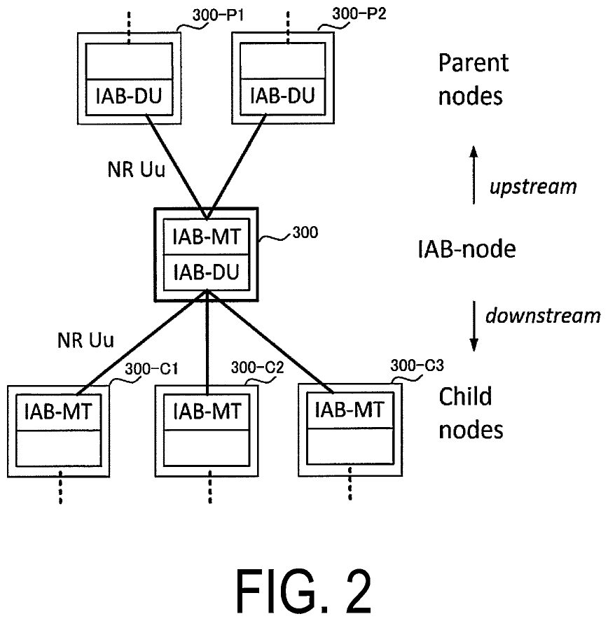

FIG. 2 is a diagram illustrating an example of a relationship between the IAB node 300, Parent nodes, and Child nodes.

As illustrated in FIG. 2, each IAB node 300 includes an IAB-DU corresponding to a base station functional unit, and an IAB-Mobile Termination (IAB-MT) corresponding to a user equipment functional unit.

Neighboring nodes (i.e., upper node) of the IAB-MT in an NR Uu wireless interface are referred to as parent nodes. The parent node is the DU of a parent IAB node or the donor node 200. A radio link between the IAB-MT and each parent node is referred to as a backhaul link (BH link). FIG. 2 illustrates an example where the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes (i.e., lower nodes) of the IAB-DU in an NR access interface are referred to as child nodes. The IAB-DU manages cells in the same manner as and/or similar manner to that of the gNB 200. The IAB-DU terminates the NR Uu wireless interface to the UE 100 and the lower IAB nodes. The IAB-DU supports the F1 protocol for the CU of the donor node 200-1. FIG. 2 illustrates an example where the child nodes of the IAB node 300 are IAB nodes 300-C1 to 300-C3, but the child nodes of the IAB node 300 may include the UE 100. Note that the direction toward the child nodes is referred to as downstream.

All of the IAB nodes 300 connected to the donor node 200 via one or more hops form a Directed Acyclic Graph (DAG) topology (that may be referred to as a “topology” below) rooted at the donor node 200. In this topology, the neighboring nodes of the IAB-DU in the interface are child nodes, and the neighboring nodes of the IAB-MT in the interface are parent nodes as illustrated in FIG. 2. The donor node 200 performs, for example, centralized management on resources, topology, and roots of the IAB topology. The donor node 200 is a gNB that provides network access to the UE 100 via a network of backhaul links and access links.

### Configuration of Base Station

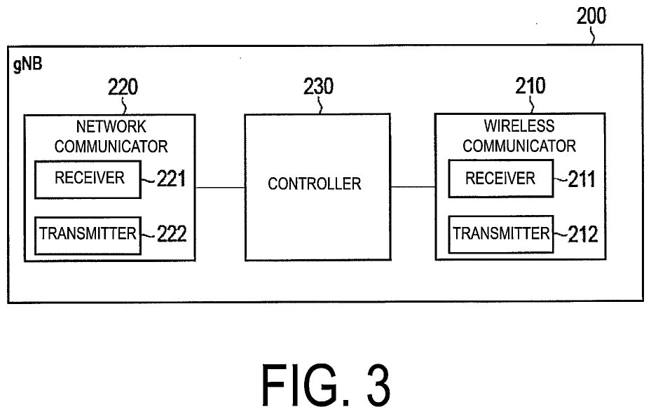

A configuration of the gNB 200 that is the base station according to the embodiment will be described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and wireless communication with the IAB node 300. The wireless communicator 210 includes a receiver 211 and a transmitter 212. The receiver 211 performs various types of reception under control of the controller 230. The receiver 211 includes an antenna, and converts (down-converts) a radio signal received by the antenna into a baseband signal (received signal), and outputs the baseband signal to the controller 230. The transmitter 212 performs various types of transmission under control of the controller 230. The transmitter 212 includes an antenna, and converts (up-converts) the baseband signal (transmission signal) output by the controller 230 into a radio signal, and transmits the radio signal from the antenna.

The network communicator 220 performs wired communication (or wireless communication) with the 5GC 10, and wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the received signal to the controller 230. The transmitter 222 performs various types of transmission under control of the controller 230. The transmitter 222 transmits the transmission signal output by the controller 230 to an external destination.

The controller 230 performs various types of control in the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory and performs various types of processing. The processor performs processing of the layers described below. Note that the controller 230 may perform each processing and each operation in the gNB 200 in each embodiment to be described below.

### Configuration of Relay Node

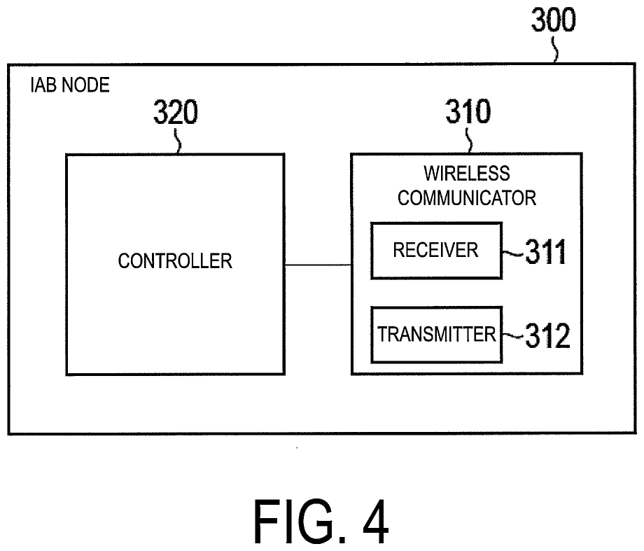

A configuration of the IAB node 300 that is a relay node (or a relay node device that may hereinafter also be referred to as a “relay node” below) according to the embodiment will be described. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). The wireless communicator 310 for BH link communication and the wireless communicator 310 for access link communication may be provided separately.

The wireless communicator 310 includes a receiver 311 and a transmitter 312. The receiver 311 performs various types of reception under control of the controller 320. The receiver 311 includes an antenna, and converts (down-converts) a radio signal received by the antenna into a baseband signal (received signal), and outputs the baseband signal to the controller 320. The transmitter 312 performs various types of transmission under control of the controller 320. The transmitter 312 includes an antenna, and converts (up-converts) the baseband signal (transmission signal) output by the controller 320 into a radio signal, and transmits the radio signal from the antenna.

The controller 320 performs various types of control in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory and performs various types of processing. The processor performs processing of the layers described below. Note that the controller 320 may perform each processing and each operation in the IAB node 300 in each embodiment to be described below.

### Configuration of User Equipment

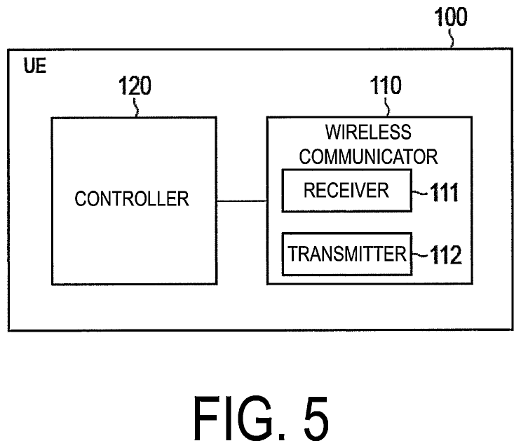

A configuration of the UE 100 that is the user equipment according to the embodiment will be described. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under control of the controller 120. The receiver 111 includes an antenna, and converts (down-converts) a radio signal received by the antenna into a baseband signal (received signal), and outputs the baseband signal to the controller 120. The transmitter 112 performs various types of transmission under control of the controller 120. The transmitter 112 includes an antenna, and converts (up-converts) a baseband signal (transmission signal) output by the controller 120 into a radio signal, and outputs the radio signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory and performs various types of processing. The processor performs processing of the layers described below. Note that the controller 120 may perform each processing in the UE 100 in each embodiment described below.

### Configuration of Protocol Stack

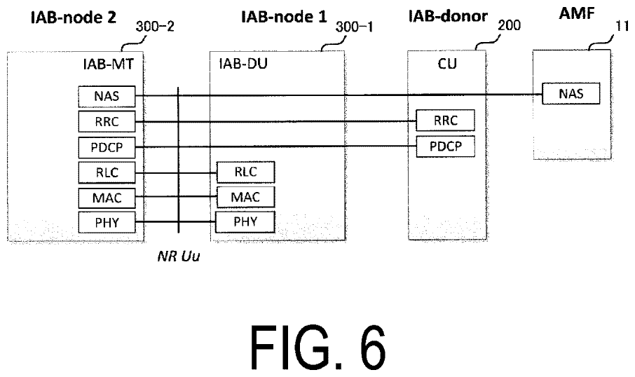

A configuration of a protocol stack according to the embodiment will be described. FIG. 6 is a diagram illustrating an example of a protocol stack related to RRC connection and NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through Hybrid Automatic Repeat reQuest (HARQ: Hybrid ARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines uplink and downlink transport formats (transport block sizes, Modulation and Coding Schemes (MCSs)) and assignment resource blocks.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When RRC connection with the donor node 200 is established, the IAB-MT is in an RRC connected state. When no RRC connection to the donor node 200 is established, the IAB-MT is in an RRC idle state.

The NAS layer that is positioned upper than the RRC layer performs session management, mobility management, and the like. NAS signaling is transmitted between the NAS layer of the IAB-MT of the IAB node 300-2 and the AMF 11.

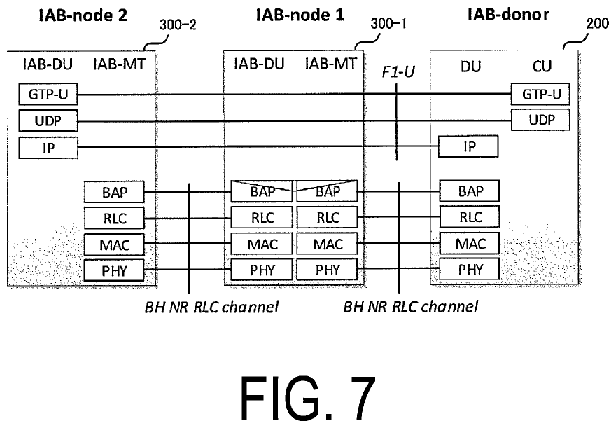

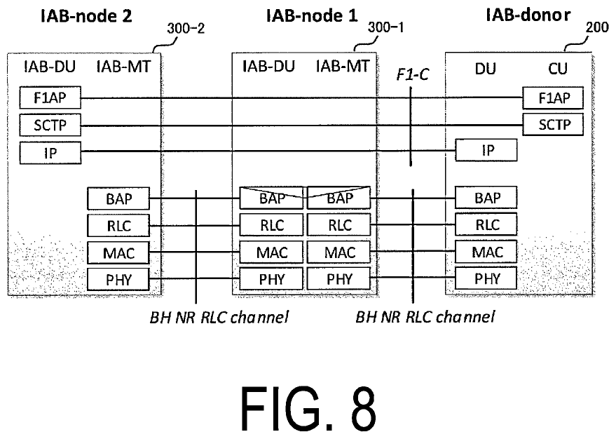

FIG. 7 is a diagram illustrating a protocol stack related to an F1-U protocol. FIG. 8 is a diagram illustrating a protocol stack related to an F1-C protocol. An example will be described where the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as an upper layer of the RLC layer. The BAP layer performs routing processing, and bearer mapping and demapping processing. In the backhaul, the IP layer is transmitted via the BAP layer to enable routing through a plurality of hops.

In each backhaul link, a Protocol Data Unit (PDU) of the BAP layer is transmitted on the backhaul RLC channel (BH NR RLC channel). Configuring a plurality of backhaul RLC channels in each BH link enables the prioritization and Quality of Service (QOS) control of traffic. The association between the BAP PDU and the backhaul RLC channel is executed by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that, in the description below, processing or an operation performed by the IAB-DU and the IAB-MT of the IAB may be simply described as processing or an operation of the “IAB”. The description assumes that, for example, transmitting a message of the BAP layer from the IAB-DU of the IAB node 300-1 to the IAB-MT of the IAB node 300-2 is to transmit the message from the IAB node 300-1 to the IAB node 300-2. Processing or an operation of the DU or CU of the donor node 200 may be described simply as processing or an operation of the “donor node”.

An upstream direction and an uplink (UL) direction may be used without distinction. A downstream direction and a downlink (DL) direction may be used without distinction.

### Mobile IAB Node

Currently, 3GPP has started a study for introducing a mobile IAB node. The mobile IAB node is, for example, an IAB node that is moving. The IAB node may be a movable IAB node. The mobile IAB node may be an IAB node having the capability to move. The mobile IAB node may be an IAB node that is currently stationary, but is certain to move in the future (or is expected to move in the future).

The mobile IAB node enables, for example, the UE 100 subordinate to the mobile IAB node to receive provision of services from the mobile IAB node as the mobile IAB node moves. For example, a case is assumed where a user (or the UE 100) who is in a vehicle receives provision of a service via the mobile IAB node installed in the vehicle.

On the other hand, there is also an IAB node that does not move with respect to the mobile IAB node. Such an IAB node may be referred to as an intermediate IAB node. The intermediate IAB node is, for example, an IAB node that does not move. The intermediate IAB node may be a stationary IAB node. The intermediate IAB node may be a stationary IAB node. The intermediate IAB node may be an IAB node that is installed at an installation place and is stationary (or does not migrate). The intermediate IAB node may be a stationary IAB node that does not migrate. The intermediate IAB node may be a fixed IAB node.

The mobile IAB node can also connect to the intermediate IAB node. The mobile IAB node can also connect to a donor node. On the other hand, the mobile IAB node can also change a connection destination by migration (or handover). A connection source may be the intermediate IAB node. The connection source may be the donor node. The connection destination may be the intermediate IAB node. The connection destination may be the donor node.

Note that, in the following description, migration of the mobile IAB node and handover of the mobile IAB node may be used without distinction.

RACH-less Handover

According to 3GPP, RACH-less handover (RACH-less HO) is stipulated (e.g., 3GPP TS 36.300 V14. 13.0 (2020-12)). RACH-less handover refers to handover that skips a random access procedure. According to RACH-less handover, for example, the following processing is performed.

That is, the UE 100 to which the RACH-less handover has been configured receives an RRCConnectionReconfiguration message from a source cell. The UE 100 is synchronized with a target cell included in the RRCConnectionReconfiguration message without executing the random access (RACH) procedure. Thereafter, the UE 100 transmits an RRCConnectionReconfigurationComplete message to the target cell by using uplink resources included in the RRCConnectionReconfiguration message, and ends a handover procedure.

The random access procedure is skipped during RACH-less handover, so that delay of a handover execution time in the UE 100 can be improved as compared with the case where the random access procedure is executed.

### Conditional Handover

According to typical handover, the UE 100 reports, to the gNB 200, a measurement value of a radio state of a serving cell and/or a neighboring cell, and the gNB 200 determines handover to the neighboring cell based on this report and transmits a handover indication to the UE 100. Accordingly, when the radio state of the serving cell rapidly deteriorates, communication disruption may occur before the handover is executed during the typical handover.

By contrast with this, according to conditional handover, when a preset trigger condition is satisfied, the UE 100 can autonomously execute handover to a candidate cell matching the trigger condition. Accordingly, problems such as communication disruption with the typical handover can be solved.

The conditional handover is configured by a conditional reconfiguration. The conditional reconfiguration may be one of Information Elements (IEs) included in an RRCReconfiguration message. The conditional reconfiguration is configured by, for example, transmitting the RRCReconfiguration message from the CU of the donor node 200 to the IAB-MT of the IAB node 300 and the UE 100. The conditional reconfiguration includes a candidate cell and an execution condition used for conditional handover. The execution condition includes one or more trigger conditions. The IAB-MT of the IAB node 300 and the UE 100 start executing handover to the candidate cell when the trigger condition is satisfied.

### Communication Control Method According to First Embodiment

There is a case where the mobile IAB node performs handover by itself to cause the UEs 100 subordinate to the mobile IAB node to perform handover simultaneously.

Handover of the mobile IAB node itself changes a cell ID of a cell that is a connection destination of the mobile IAB node. It is conceivable that, when the cell ID of the connection destination of the mobile IAB node is changed by the handover, it is easy to manage the UE 100 subordinate to the mobile IAB node by changing the cell ID that is the connection destination of the UE 100 subordinate to the mobile IAB node, too. Hence, the above-described case is assumed.

In such a case, if the distance (or position) of the UE 100 subordinate to the mobile IAB node to the mobile IAB node does not change, an execution time of the handover procedure can be reduced by causing the UE 100 to perform RACH-less handover.

Generally, the CU performs the RRC configuration. On the other hand, the DU manages a cell.

For example, the DU of the gNB 200 (or the donor node) may recognize a cell whose Timing Advance (TA) value is the same among cells managed by the DU. For example, the IAB-DU of the mobile IAB node may also recognize the distance to the subordinate UE 100 as described above.

However, the CU (the CU of the gNB 200 or the CU of the donor node 200) does not recognize a situation of the cell, and therefore there is a case where RACH-less handover cannot be appropriately configured to the UE 100. In this case, the UE 100 cannot appropriately connect to the network.

Hence, the UE 100 is enabled to appropriately connect to the network in the first embodiment.

Hence, in the first embodiment, the base station (e.g., the gNB 200 or the donor node 200) transmits to the user equipment (e.g., the UE 100 subordinate to the gNB 200 or the UE 100 subordinate to an mobile IAB node 300M) the conditional reconfiguration including permission information representing whether connection by the RACH-less handover is permitted for each target cell.

Thus, at the time of handover, the UE 100 can determine to which target cell the UE 100 needs to connect to be able to perform RACH-less handover. Accordingly, if connection by the RACH-less handover is permitted for the target cell, the UE 100 can execute the RACH-less handover to the target cell. Accordingly, the UE 100 can appropriately connect to the network.

### Operation Example According to First Embodiment

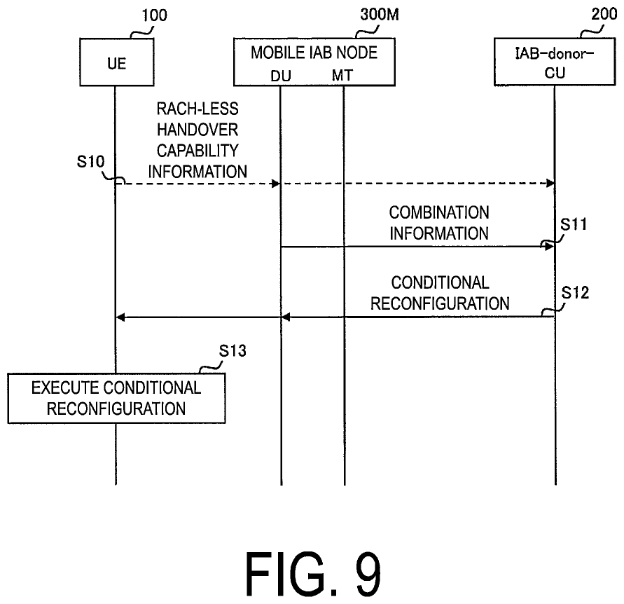

FIG. 9 is a diagram illustrating an operation example according to the first embodiment. In the example illustrated in FIG. 9, the UE 100 is a UE subordinate to the mobile IAB node 300M, and performs handover accompanying handover of the mobile IAB node 300M.

In this case, for the UE 100, the source cell is a cell to which the mobile IAB node 300M has been connected prior to the handover (e.g. a cell managed by the DU of the donor node 200). For the UE 100, the target cell may be a cell to which the mobile IAB node 300M has been connected by handover (e.g., it may be a cell managed by the DU of the donor node 200, and the target cell may be a cell managed by the IAB-DU of an intermediate IAB node 300S subordinate to the DU).

As illustrated in FIG. 9, in step S10, the UE 100 may transmit to the CU of the donor node 200 (IAB-donor-CU) RACH-less handover capability information representing that the UE 100 itself has capability to execute the RACH-less handover. The RACH-less handover capability information may be information representing that the UE 100 supports RACH-less handover. The UE 100 may transmit an RRC message including the RACH-less handover capability information to the IAB-DU of the mobile IAB node 300M. The IAB-DU of the mobile IAB node 300M may transmit an F1 message including the RRC message to the CU of the donor node 200.

In step S11, the IAB-DU of the mobile IAB node 300M transmits, to the CU of the donor node 200, combination information representing a combination of cells to which the RACH-less handover can be performed among the cells managed by the IAB-DU. The IAB-DU of the mobile IAB node 300M may transmit the F1 message including the combination information to the CU of the donor node 200.

Note that, prior to step S11, the CU of the donor node 200 may request the combination information to the mobile IAB node 300M. In this case, the CU of the donor node 200 may transmit the F1 message including the request for the combination information to the IAB-DU of the mobile IAB node 300M.

First, the combination of cells may be cells that geographically exist at the same place. This is, for example, a case where the source cell and the target cell are physically identical. There is a case where, while the UE 100 moves accompanying handover of the mobile IAB node 300M, the position of the UE 100 with respect to the mobile IAB node 300M does not change.

Second, the combination of cells may be cells whose Timing Advance (TA) values are the same between the first cell and the second cell. When the UE 100 moves from the source cell to the target cell, if a distance from the source cell to the UE 100 is the same as a distance from the target cell to the UE 100, the TA values are the same. Such a combination of the source cell and the target cell may be indicated by the combination information. The IAB-DU of the mobile IAB node 300M may recognize the combination of cells whose TA values are the same from a past handover history of the subordinate UE 100.

Third, the combination of cells may be a combination of cells before and after change caused by the handover of the mobile IAB node 300M. When, for example, the mobile IAB node 300M is handed over from the first cell to the second cell, the combination of the first cell and the second cell may be a combination of cells to which RACH-less handover can be performed.

The combination information may include the above-described combinations of cells in a list format. The combinations of cells may be indicated by combinations of cell IDs of the cells.

The combination information may include, for each combination of cells, a TA value to be applied when the UE 100 executes RACH-less handover. The TA value may be transmitted separately from the combination information.

In step S12, the CU of the donor node 200 configures the conditional reconfiguration to the UE 100. For example, the CU of the donor node 200 generates an RRC message (e.g., RRCReconfiguration message) including the conditional reconfiguration based on the combination information, and transmits the F1 message in which the RRC message is included (or encapsulated) to the IAB-DU of the mobile IAB node 300M. The IAB-DU of the mobile IAB node 300M extracts the RRC message from the F1 message and transmits the RRC message to the UE 100.

The conditional reconfiguration includes permission information representing whether connection by RACH-less handover is permitted for each target cell. The permission information may represent whether execution of RACH-less handover is permitted for each target cell.

First, based on the combination information (step S11), the CU of the donor node 200 may use a combination target cell as a target cell to which connection by RACH-less handover is permitted. The CU of the donor node 200 may use a cell that is not included in the combination information as the target cell to which connection by the RACH-less handover is not permitted. When determining based on the combination information that the TA value of the target cell takes the same value as the TA value of the source cell, the CU of the donor node 200 may permit connection by RACH-less handover to the target cell.

Second, the permission information representing that connection by RACH-less handover is permitted may represent that execution of RACH-less handover to the target cell is indicated. The conditional reconfiguration that does not include PRACH resources specific to the UE 100 may implicitly represent that execution of RACH-less handover is indicated. The conditional reconfiguration including a radio resource (PUSCH resource) for the UE 100 to transmit the RRCReconfigurationComplete message to the target cell may represent that execution of RACH-less handover is indicated.

In step S13, the UE 100 executes the conditional reconfiguration when a trigger condition of the conditional reconfiguration is satisfied. At this time, the UE 100 confirms based on the permission information whether connection by RACH-less handover to the target cell is permitted. When confirming that connection by RACH-less handover to the target cell is permitted, the UE 100 executes RACH-less handover to the target cell and connects to the target cell. On the other hand, when confirming that connection by RACH-less handover to the target cell is not permitted, the UE 100 executes a random access procedure for the target cell and connects to the target cell.

### Another Example 1 According to First Embodiment

The example where the conditional reconfiguration includes the permission information has been described in the first embodiment. However, the present disclosure is not limited thereto. For example, the permission information may be included in an RRCReconfiguration message for executing normal handover instead of conditional handover. In this case, the CU of the donor node 200 generates the RRCReconfiguration message including the permission information based on the combination information (step S11), and transmits the F1 message including the RRCReconfiguration message to the IAB-DU of the mobile IAB node 300M. The IAB-DU of the mobile IAB node 300M transmits the RRCReconfiguration message to the UE 100. In response to reception of the RRCReconfiguration message, the UE 100 executes the normal handover procedure instead of conditional handover. At this time, as in the first embodiment, the UE 100 confirms based on the permission information whether the RACH-less handover to the target cell can be performed, and performs subsequent processing. Another Example 2 According to First Embodiment

The example has been described in the first embodiment where the conditional reconfiguration is configured between the donor node 200, the mobile IAB nodes 300M, and the UE 100. However, the present disclosure is not limited thereto. For example, the conditional reconfiguration may be configured between the gNB 200 and the UE 100.

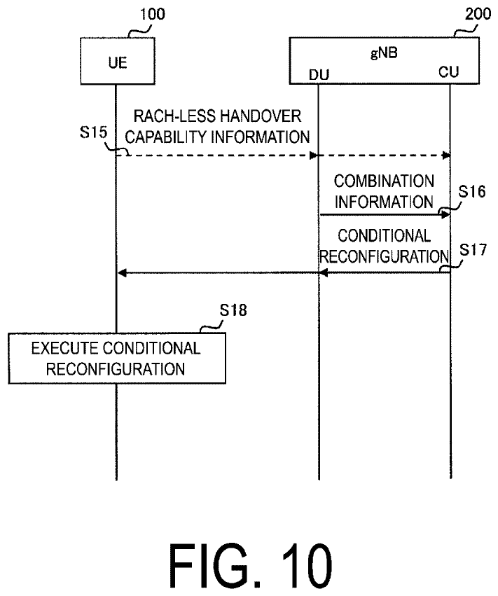

FIG. 10 is a diagram illustrating another operation example according to the first embodiment. In the example illustrated in FIG. 10, the UE 100 executes conditional handover from the source cell managed by the DU of the gNB 200 to the target cell managed by the DU of the gNB 200.

As in the first embodiment, the UE 100 may transmit RACH-less handover capability information to the CU of the gNB 200 (step S15). In this case, the UE 100 may transmit an

RRC message including the RACH-less handover capability information to the DU of the gNB 200, and the DU of the gNB 200 may transmit the F1 message including the RRC message to the CU of the gNB 200.

The DU of the gNB 200 transmits (the F1 message including) the combination information to the CU of the gNB 200 (step S16). As in the first embodiment, the combination information includes a combination of cells to which RACH-less handover can be performed.

The CU of the gNB 200 generates the conditional reconfiguration including permission information based on the combination information, and transmits the conditional reconfiguration to the UE 100 (step S17). The CU of the gNB 200 may generate the RRC message including the conditional reconfiguration, and transmit the F1 message including the RRC message to the DU of the gNB 200. The DU of the gNB 200 may extract the RRC message from the F1 message, and transmit the RRC message to the UE 100.

When the trigger condition is satisfied, the UE 100 executes the conditional reconfiguration and executes conditional handover (step S18). When confirming based on the permission information that connection by RACH-less handover to the target cell is permitted, the UE 100 executes RACH-less handover to the target cell. On the other hand, when confirming based on the permission information that connection by RACH-less handover to the target cell is not permitted, the UE 100 executes the random access procedure for the target cell.

As in the first embodiment, in a case in FIG. 10, too, the UE 100 can connect to the target cell, and consequently can appropriately connect to the network.

### Another Example 3 According to First Embodiment

The example of the mobile IAB node 300M has been described in the first embodiment. However, for example, an IAB node (the intermediate IAB node 300S or an access IAB node. The access IAB node refers to an IAB node that serves the UE 100) may be also used instead of the mobile IAB node 300M. For example, in FIG. 9, the mobile IAB node 300M may be read as the intermediate IAB node 300S and used.

### Another Example 4 According to First Embodiment

In another example 2 according to the first embodiment, an example performed between the gNB 200 and the UE 100 has been described. However, for example, it is also possible to perform between the donor node 200 and the mobile IAB node 300M. For example, in FIG. 10, the gNB 200 may be read as the donor node 200, and the UE 100 may be read as the mobile IAB node 300M. In this case, the DU of the donor node 200 transmits the combination information to the CU of the donor node 200 (step S16). The CU of the donor node 200 generates the conditional reconfiguration including the permission information based on the combination information, and transmits the conditional reconfiguration to the IAB-MT of the mobile IAB node 300M (step S17).

### Second Embodiment

A second embodiment will be described.

The case has been described in the first embodiment where, when the mobile IAB node 300M performs handover, the mobile IAB node 300M collectively hands over the subordinate UEs 100.

In such a case, the mobile IAB node 300M may simultaneously transmit an RRCReconfiguration message to each subordinate UE 100 to indicate execution of handover.

However, when the mobile IAB node 300M simultaneously transmits the message, the message is individually transmitted to each UE 100 as compared with the case where the message is not transmitted, and therefore a load of radio resources in the downlink direction becomes high. In the UE 100 subordinate to the mobile IAB node 300M, a service may be interrupted due to simultaneous transmission of the messages.

Hence, 3GPP has proposed two solutions for reducing service interruption (“Solution 1 for reduction of service interruption” and “Solution 2 for reduction of service interruption”). The solution 1 has been specified among these solutions.

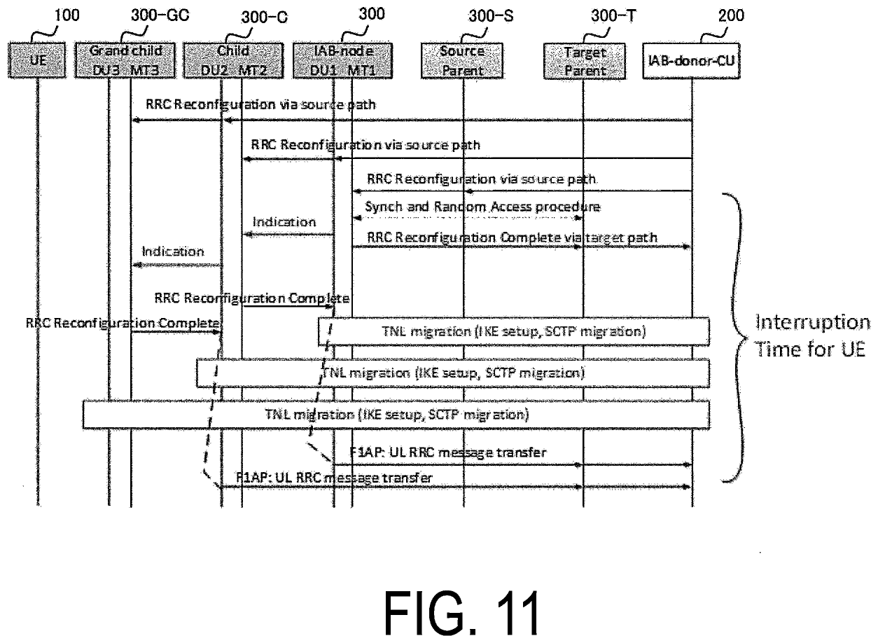

FIG. 11 is a diagram illustrating an operation example of the solution 2 (Solution 2 for reduction of service interruption). In the example illustrated in FIG. 11, the CU of the donor node 200 (IAB-donor-CU) transmits RRCReconfiguration messages to the IAB node 300, a child node 300-C thereof, and a grandchild node 300-GC thereof, and the IAB node 300, the child node 300-C, and the grandchild node 300-GC are handed over.

The two solutions are both examples where, before each of the IAB node 300, 300-C and 300-GC is handed over, the CU of the donor node 200 transmits the RRCReconfiguration messages. The RRCReconfiguration message is transmitted in advance to each of the IAB nodes 300, 300-C and 300-GC, so that the load can be balanced as compared with the case where the messages are simultaneously transmitted. By balancing the load, the service interruption to the UE 100 subordinate to each of the IAB nodes 300, 300-C and 300-GC can be reduced.

Note that, as illustrated in FIG. 11, the solution 2 is the solution that execution of the RRCReconfiguration message is suspended in an IAB-MT of a child node. In this case, the IAB-MT of the child node receives an Indication from the DU of the parent node (i.e., IAB node) and starts executing the message.

On the other hand, the solution 1 is the solution that forwarding of the RRCReconfiguration message is suspended (or buffered) in an IAB-DU of a parent IAB node. According to the solution 1, when a certain condition is satisfied, the suspended message is transmitted.

The solution 2 is focused upon in the second embodiment. Regarding the solution 2, for example, a relationship between the mobile IAB node 300M and the UE 100 subordinate to the mobile IAB node 300M is as follows.

That is, the CU of the donor node 200 transmits the RRCReconfiguration message to the UE 100 subordinate to the mobile IAB node 300M. The DU of the mobile IAB node 300M transmits an execution indication (“Indication” illustrated in FIG. 11) to the UE 100. In response to reception of the execution indication, the UE 100 starts execution of the RRCReconfiguration message.

However, the DU of the mobile IAB node 300M does not know at which timing the execution indication (“Indication” illustrated in FIG. 11) needs to be transmitted. When a transmission timing of the execution indication is not appropriate, the UE 100 cannot appropriately connect to the target cell. Therefore, the UE 100 may not be able to appropriately connect to the network.

Hence, in the second embodiment, the UE 100 is enabled to appropriately connect to the network as in the first embodiment.

In the second embodiment, the CU of the donor node 200 configures a conditional reconfiguration to the UE 100, and then transmits a transmission indication of the execution indication to the mobile IAB node 300M. The mobile IAB node 300M transmits the execution indication to the UE 100 in response to reception of the transmission indication. Upon receiving the execution indication, the UE 100 starts execution of the conditional reconfiguration.

More specifically, first, the donor node (e.g., donor node 200) transmits the conditional reconfiguration including an execution condition to be executed in response to reception of the execution indication to a user equipment (e.g., UE 100) subordinate to a mobile relay node (e.g., mobile IAB node 300M). Second, the donor node transmits a transmission indication for indicating transmission of the execution indication to the mobile relay node. Third, the mobile relay node transmits the execution indication to the user equipment in response to reception of the transmission indication.

Thus, for example, the mobile IAB node 300M can receive the transmission indication from the donor node 200 and transmit the execution indication to the UE 100, and consequently can transmit the execution indication to the UE 100 at an appropriate timing. Accordingly, the UE 100 can execute the conditional reconfiguration at an appropriate timing and perform handover to the target cell. Accordingly, the UE 100 can appropriately connect to the network.

### Operation Example According to Second Embodiment

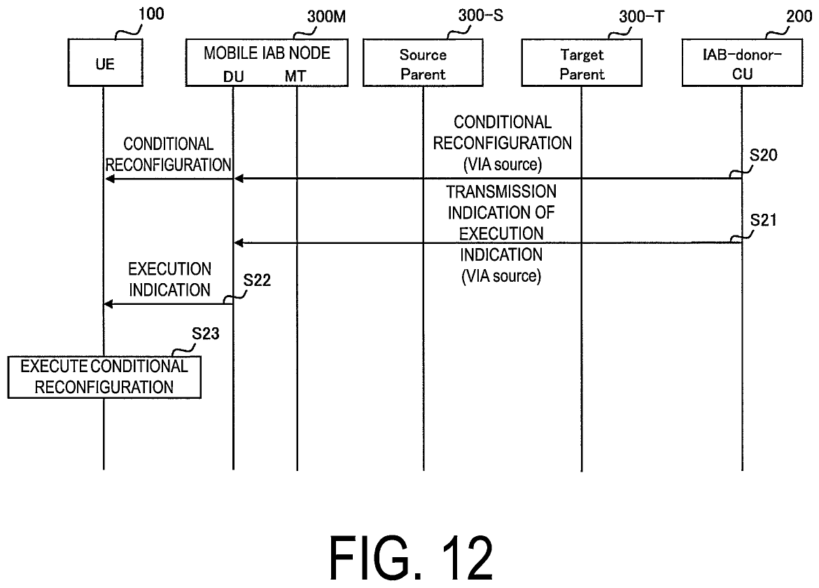

FIG. 12 is a diagram illustrating an operation example according to the second embodiment.

Note that FIG. 12 illustrates an example where the mobile IAB node 300M is handed over from the Source Parent node 300-S to a Target Parent node 300-T. FIG. 12 illustrates an example where the subordinate UE 100 is also handed over accompanying handover of the mobile IAB node 300M. The source parent node 300-S and the target parent node 300-T may be the intermediate IAB nodes 300S subordinate to the donor node 200.

As illustrated in FIG. 12, in step S20, the CU of the donor node 200 configures the conditional reconfiguration to the UE 100. For example, the CU of the donor node 200 generates an RRC message (e.g., RRC reconfiguration (HO command) message) including the conditional reconfiguration, and transmits an F1 message including the RRC message to the IAB-DU of the mobile IAB node 300M. The IAB-DU of the mobile IAB node 300M extracts the RRC message including the conditional reconfiguration from the F1 message, and transmits the RRC message to the UE 100.

The conditional reconfiguration may include a plurality of entries each one of which is one configuration. At least one of the plurality of entries includes an execution condition “execute in response to an execution indication” (or “execute when an execution indication is received”). Thus, the UE 100 does not start execution of the execution condition even when the conditional reconfiguration is received, but starts execution in response to reception of the execution indication from the mobile IAB node 300M, and thereby can perform the operation corresponding to the above-described solution 2.

In step S21, the CU of the donor node 200 transmits the transmission indication of the execution indication to the IAB-DU of the mobile IAB node 300M.

First, the CU of the donor node 200 may generate an RRC message including the transmission indication, and transmit the F1 message including the RRC message to the IAB-DU of the mobile IAB node 300M. The CU of the donor node 200 may transmit the F1 message including the transmission indication to the IAB-DU of the mobile IAB node 300M.

Second, the transmission indication may include a UE identifier of the UE 100 that is a transmission destination of the transmission indication. The transmission indication may include a conditional reconfiguration identifier that is a transmission target of the transmission indication. The identifier represents, for example, information indicating whether at least one conditional reconfiguration of the plurality of conditional reconfigurations is the transmission target. The transmission indication may include an entry number of a list in the conditional reconfiguration that is the transmission target of the transmission indication.

Third, the transmission indication may include an indication representing that the execution indication is immediately transmitted. The transmission indication may include an indication representing that the execution indication is transmitted at a time of execution of conditional handover. The transmission indication may include an indication representing that the execution indication is transmitted at the time of execution of handover. The transmission indication may include an indication representing that the execution indication is transmitted at the time of transmission of the RRCReconfigurationComplete message.

In step S22, the IAB-DU of the mobile IAB node 300M transmits the execution indication to the UE 100. For example, the IAB-DU of the mobile IAB node 300M transmits the execution indication for the conditional reconfiguration specified in the transmission indication to the UE 100 specified in the transmission indication (step S21).

The execution indication may be included in a MAC control element (MAC CE) and transmitted. The execution indication may be included in a BAP Control PDU and transmitted. The execution indication also includes a conditional reconfiguration identifier that is an execution target. The identifier represents, for example, information representing whether at least one conditional reconfiguration is to be executed among the plurality of conditional reconfigurations. The execution indication may include an entry number of a list in the conditional reconfiguration that is the execution target.

In step S23, the UE 100 executes the designated conditional reconfiguration, and executes handover to the target cell C2.

Another Example 1 According to Second Embodiment The mobile IAB node 300M has been described in the second embodiment. However, the present disclosure is not limited thereto. For example, instead of the mobile IAB node 300M, even the intermediate IAB node 300S can be used. In this case, by executing the conditional reconfiguration, the UE 100 subordinate to the intermediate IAB node 300S can be handed over from the serving cell managed by the intermediate IAB node 300S to the target cell managed by the intermediate IAB node 300S (or the target cell managed by another intermediate IAB node 300S). For example, the operation example illustrated in FIG. 12 can be implemented by reading the mobile IAB node 300M as the intermediate IAB node 300S in FIG. 12.

### Another Example 2 According to Second Embodiment

In the second embodiment, the example where the conditional reconfiguration is configured between the UE 100, the mobile IAB node 300M, and the donor node 200 has been described. However, the present disclosure is not limited thereto. For example, the conditional reconfiguration described in the second embodiment is also applicable between the UE 100 and the gNB 200.

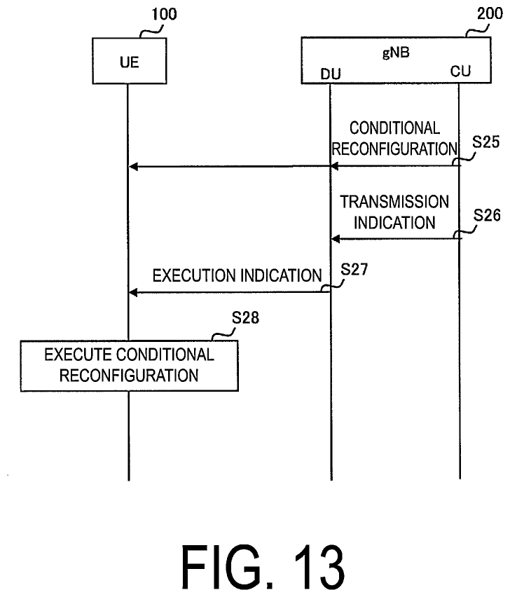

FIG. 13 is a diagram illustrating another operation example according to the second embodiment.

As illustrated in FIG. 13, the CU of the gNB 200 configures the conditional reconfiguration to the UE 100 as in the second embodiment (step S25). What is the same as and/or similar to the second embodiment is that at least one of the entries included in the conditional reconfiguration includes the execution condition “execute in response to an execution indication”. As in the second embodiment, the UE 100 does not immediately execute the conditional reconfiguration for the corresponding entry even if the conditional reconfiguration is configured, and waits until the execution indication is received.

The CU of the gNB 200 transmits the transmission indication of the execution indication to the DU of the gNB 200 (step S26). Contents of the transmission indication and the information included in the transmission indication may be also the same as and/or similar to those in the second embodiment.

In response to reception of the transmission indication, the DU of the gNB 200 transmits the execution indication to the UE 100 (step S27). Upon reception of the execution indication, the UE 100 starts the indicated execution condition and executes handover to the target cell as in the second embodiment (step S28).

### Third Embodiment

A third embodiment will be described.

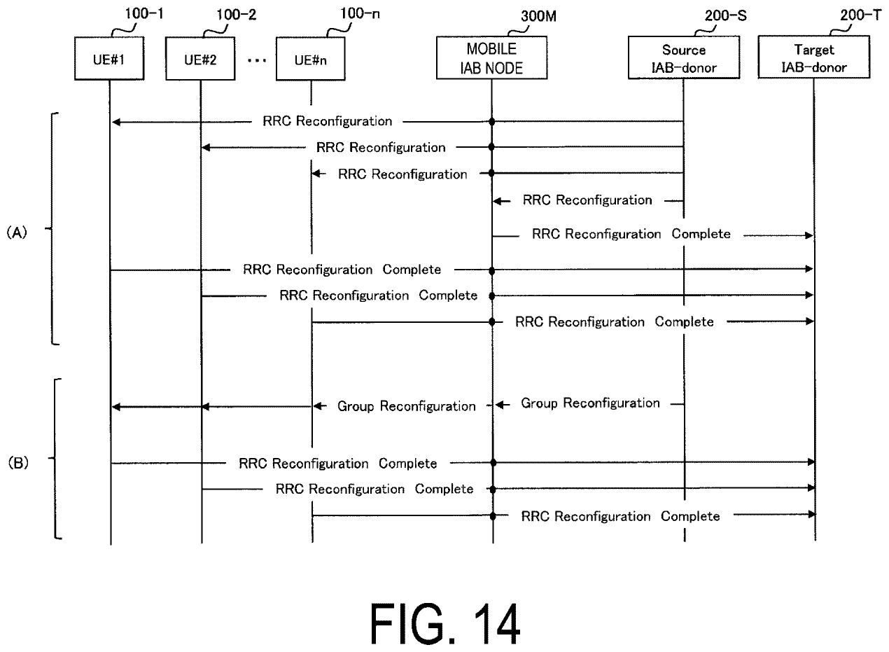

Currently, 3GPP is scheduled to study group handover of the mobile IAB node 300M. The group handover is handover simultaneously performed by a plurality of the UEs 100 as one group. According to group handover of the mobile IAB node 300M, the mobile IAB node 300M is also included in the group and becomes a handover target.
(A) of FIG. 14 and (B) of FIG. 14 are diagrams illustrating operation examples of group handover according to the third embodiment. (A) of FIG. 14 illustrates the example where a Source IAB-donor node 200-S transmits an RRCReconfiguration message that is a handover command to each of UEs 100-1, . . . , and 100-n and the mobile IAB node 300M.

On the other hand, in (B) of FIG. 14, the source donor node 200-S transmits a GroupReconfiguration message (including the F1 message) to the mobile IAB node 300M. The GroupReconfiguration message includes, for example, configuration information of group handover. The GroupReconfiguration message is, for example, a message indicating a group handover indication. The mobile IAB node 300M transmits the GroupReconfiguration message to each of the UEs 100-1, . . . , and 100-n.

In the example illustrated in (B) of FIG. 14, the configuration information of group handover is transmitted from the source donor node 200-S to the mobile IAB node 300M by one F1 message. As compared with a case where an individual message (F1 message) is transmitted from the source donor node 200-S to the mobile IAB node 300M for each of the UEs 100-1, . . . , and 100-n ((A) of FIG. 14), group handover can be configured to the plurality of UEs 100-1, . . . , and 100-n by the one F1 message. Thus, in the example illustrated in (B) of FIG. 14, a load of F1 signaling can be reduced as compared with the example illustrated in (A) of FIG. 14. In particular, as for the IAB, since the F1 signaling is also wireless, load reduction of the F1 signaling is also considered effective as compared with the case where signaling is performed by wire.

On the other hand, it is assumed that the mobile IAB node 300M is not the UE 100 dedicated to Rel-18, but also permits connection of the UE 100 according to Rel-17 and previous releases. Hence, it is desirable that at least the mobile IAB node 300M transmits not a new RRCReconfiguration message for group handover, but an RRCReconfiguration message that the UE 100 according to Rel-17 and the previous releases can also receive.

Hereinafter, an example will be described in the third embodiment where, when receiving from the donor node the common configuration common to the group and the individual configuration specific to the UE, the mobile IAB node 300M combines the common configuration and the individual configuration and transmits to each UE 100 an RRCReconfiguration message that the UE 100 according to Rel-17 and the previous releases can also receive.

More specifically, first, a donor node (e.g., source donor node 200-S) transmits to a mobile relay node (e.g., mobile IAB node 300M) a first message including the common configuration common to a plurality of user equipments (e.g., UEs 100) subordinate to the mobile relay node. Second, the donor node transmits to the mobile relay node a second message including the individual configuration of each user equipment subordinate to the mobile relay node. Third, the mobile relay node transmits the RRCReconfiguration message including the common configuration and the individual configuration to each user equipment.

Thus, for example, the message including the common configuration enables the common configuration to the UEs 100 in the group by one message. Accordingly, as compared with the case where each message is transmitted to each UE as illustrated in (A) of FIG. 14, F1 signaling can be reduced in the second embodiment.

As, for example, the message transmitted to the UE 100, the RRCReconfiguration message that the UEs 100 according to Re-17 and the previous releases can also receive is used. Thus, the UEs 100 according to Re-17 and the previous releases can also appropriately connect to the target cell by group handover. Accordingly, the UE 100 can appropriately connect to the network as in the first embodiment.

### Operation Example According to Third Embodiment

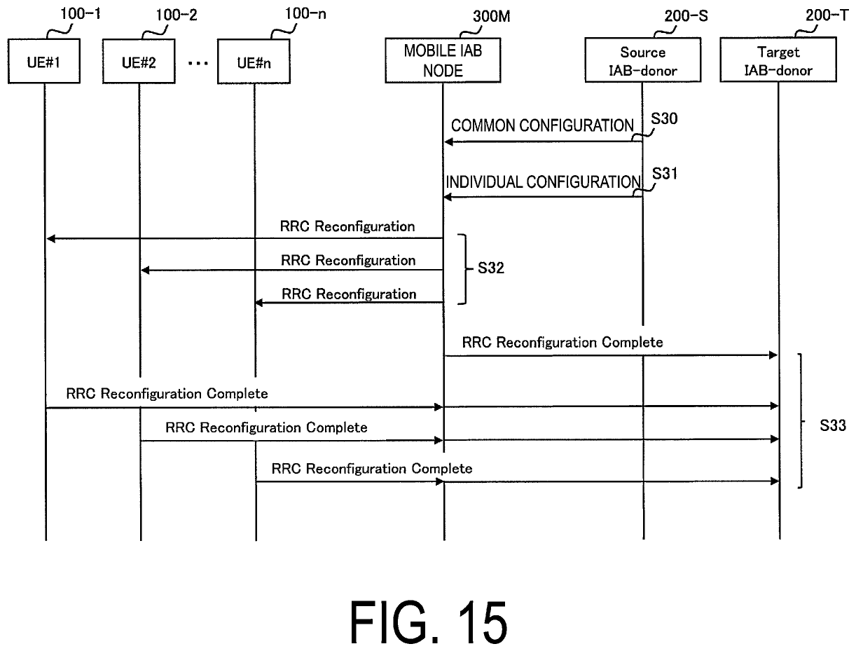

FIG. 15 is a diagram illustrating an operation example according to the third embodiment.

The example illustrated in FIG. 15 is an example where the mobile IAB node 300M is handed over from a source donor node (Source IAB-donor node) 200-S to a target donor node (Target IAB-donor node) 200-T. The example illustrated in FIG. 14 is an example where the UEs 100-1, . . . , and 100-n subordinate to the mobile IAB node 300M also become one group and perform group handover accompanying handover of the mobile IAB node 300M. Hereinafter, a group that is formed by the plurality of UEs 100-1, . . . , and 100-n to perform group handover may be referred to as a “UE group”.

As illustrated in FIG. 15, in step S30, the CU of the source donor node 200-S transmits a common configuration of the UE group to the IAB-DU of the mobile IAB node 300M.

First, the CU of the source donor node 200-S may generate an RRC message (e.g., RRCReconfiguration message) including the common configuration, and transmit an F1 message including the RRC message to the mobile IAB node 300M. The CU of the source donor node 200-S may transmit the F1 message including the common configuration to the mobile IAB node 300M. In both cases, the F1 message is an example of the first message.

Second, the common configuration includes a configuration common to the UEs 100-1, . . . , and 100-n belonging to the UE group. The configuration may be a configuration value itself. The configuration may be indicated as an Information Element (IE). The message including the common configuration may include a UE group identifier representing an identifier of the UE group. The message including the common configuration may include a list of UE identifiers of the UEs 100 belonging to the UE group. The list of the UE group identifiers and/or the UE identifiers may be included in the common configuration.

In step S31, the CU of the source donor node 200-S transmits an individual configuration of the UE group to the IAB-DU of the mobile IAB node 300M.

First, the CU of the source donor node 200-S may generate an RRC message (e.g., RRCReconfiguration message) including the individual configuration, and transmit the F1 message including the RRC message to the mobile IAB node 300M. The CU of the source donor node 200-S may transmit the F1 message including the individual configuration to the mobile IAB node 300M. In both cases, the F1 message is an example of the second message.

Second, the individual configuration includes an individual configuration for each of the UEs 100-1, . . . , and 100-n belonging to the UE group. The configuration may be a configuration value itself. The configuration may be indicated as an Information Element (IE).

The message including the individual configuration includes the UE identifiers of the UEs 100 belonging to the UE group. The UE identifier represents the UE 100 that is a target of the individual configuration. The UE identifier may be included in the individual configuration.

In step S32, the IAB-DU of the mobile IAB node 300M combines the common configuration and the individual configuration, and generates an RRCReconfiguration message including the common configuration and the individual configuration. The RRCReconfiguration message is an RRCReconfiguration message that the UEs 100 according to Rel-17 and the previous releases can also receive.

Note that, when the common configuration and the individual configuration include the same configuration, the IAB-DU of the mobile IAB node 300M may suppress the same configuration from being included in both of the common configuration and the individual configuration by giving priority to the configuration of the individual configuration.

The IAB-DU of the mobile IAB node 300M transmits the generated RRCReconfiguration message to each of the UEs 100-1, . . . , and 100-n belonging to the UE group.

Thereafter, in step S33, the IAB-MT of the mobile IAB node 300M and each of the UEs 100-1, . . . , and 100-n transmit RRCReconfigurationComplete messages to the Target IAB-donor node 200-T, and complete group handover.

### Another Example 1 According to Third Embodiment

The example has been described in the third embodiment where the UE 100 subordinate to the mobile IAB node 300M performs group handover. However, the present disclosure is not limited thereto. For example, the UE 100 subordinate to the gNB 200 may also perform group handover.

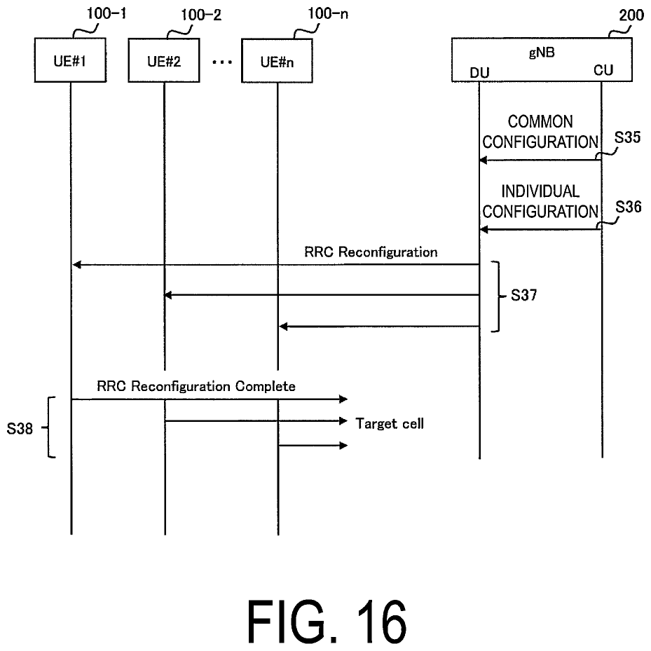

FIG. 16 is a diagram illustrating another operation example according to the third embodiment.

FIG. 16 illustrates an example where the UEs 100-1, . . . , and 100-n subordinate to the gNB 200 form a UE group and the UEs 100-1, . . . , and 100-n perform group handover.

As illustrated in FIG. 16, the CU of the gNB 200 transmits the common configuration to the DU of the gNB 200 (step S35). As in the third embodiment, the CU of the gNB 200 may generate an RRC message (e.g., RRCReconfiguration message) including the common configuration, and transmit an F1 message including the RRC message to the DU of the gNB 200. The CU of the gNB 200 may transmit the F1 message including the common configuration to the DU of the gNB 200 as in the third embodiment. The common configuration itself may be identical to that in the third operation example.

The CU of the gNB 200 transmits the individual configuration to the DU of the gNB 200 (step S36). As in the third embodiment, the CU of the gNB 200 may generate the RRC message (e.g., RRCReconfiguration message) including the individual configuration, and transmit the F1 message including the RRC message to the DU of the gNB 200. The CU of the gNB 200 may transmit the F1 message including the individual configuration to the DU of the gNB 200 as in the third embodiment. The individual configuration itself may be identical to that of the third embodiment.

The DU of the gNB 200 combines the common configuration and the individual configuration, and transmits the RRCReconfiguration message including the common configuration and the individual configuration to each of the UEs 100-1, . . . , and 100-n (step S38). What is the same as and/or similar to the third embodiment is that the RRCReconfiguration message is an RRCReconfiguration message that the UE 100 according to Rel-17 and the previous releases can also receive. Each of the UEs 100-1, . . . , and 100-n transmits an RRCReconfigurationComplete message to the target cell and completes the handover (step S38).

### OTHER EMBODIMENTS

A program that causes a computer to execute each of the processing operations performed by the UE 100, the gNB 200, or the IAB node 300 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing each processing performed by the UE 100, the gNB 200, or the IAB node 300 may be integrated, and at least part of the UE 100 or the gNB 200 may be configured as a semiconductor integrated circuit (a chipset or a System on a chip (SoC)).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on” likewise. The terms “include” and “comprise” do not mean the inclusion of only the listed items but rather the inclusion of only the listed items or the inclusion of additional items in addition to the listed items. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure. The embodiments, the operation examples, or the processing can be also combined as appropriate as long as the embodiments, the operation examples, or the processing are not inconsistent with each other.

### First Supplementary Note

### Supplementary Note 1

A communication control method used in a cellular communication system includes a step of transmitting, at a base station to a user equipment, a conditional reconfiguration including permission information representing whether connection by RACH-less handover is permitted per target cell.

### Supplementary Note 2

According to the communication control method described in Supplementary Note 1, the base station is a donor node, and the user equipment is a user equipment subordinate to a mobile relay node.

### Supplementary Note 3

The communication control method described in Supplementary Note 1 or Supplementary Note 2 further includes a step of transmitting, at the mobile relay node, to the donor node, combination information representing combinations of cells to which connection by the RACH-less handover is possible, and the step of transmitting the conditional reconfiguration includes a step of transmitting, at the base station, the conditional reconfiguration based on the combination information.

### Supplementary Note 4

According to the communication control method described in any one of Supplementary Note 1 to Supplementary Note 3, the step of transmitting the combination information includes a step of transmitting, at the mobile relay node, a timing advance value of each of the combinations.

### Supplementary Note 5

A communication control method used in a cellular communication system includes a step of transmitting, at a donor node to a user equipment subordinate to a mobile relay node, a conditional reconfiguration including an execution condition executed in receiving an execution indication, a step of transmitting, at the donor node to the mobile relay node, a transmission indication indicating transmission of the execution indication, and a step of transmitting, at the mobile relay node to the user equipment, the execution indication in response to reception of the transmission indication.

### Supplementary Note 6

According to the communication control method described in Supplementary Note 5, the step of transmitting the execution indication includes a step of transmitting, at the mobile relay node, the execution indication including information representing whether at least one conditional reconfiguration of a plurality of the conditional reconfigurations is to be executed.

### Supplementary Note 7

A communication control method used in a cellular communication system includes a step of transmitting, at a donor node to a mobile relay node, a first message including a common configuration common to a plurality of user equipments subordinate to the mobile relay node, a step of transmitting, at the donor node to the mobile relay node, a second message including an individual configuration of each of the plurality of user equipments subordinate to the mobile relay node, and a step of transmitting, at the mobile relay node to each of the plurality of user equipments, an RRC reconfiguration message including the common configuration and the individual configuration.

### Second Supplementary Note

### 1. Introduction

RAN #94e has approved a new work item related to a mobile IAB. This WID has been revised in RAN #96 as follows.

A detailed target of this work item is follows.
A transition/topology adaptation procedure to enable mobility of IAB nodes is defined. This includes inter-donor transition (complete transition) of all the mobile IAB nodes.
Mobility of the IAB node and a UE for which this IAB node serves is enhanced. This includes an aspect related to group mobility. Optimization is not performed targeting at surrounding UEs.

Note: The solution needs to be suppressed from touching on a topic that has already been discussed for Rel-17 or a topic that has been excluded from Rel-17 except for enhancement of functions specific to IAB node mobility.
Mitigation of an interference due to mobility of the IAB node such as collision of a reference signal and a control signal (such as a PCI and a RACH) needs to be avoided.

Note: At a time of start of work, RAN3 and RAN2 need to discuss potential complexity between a scenario that the mobile IAB node connects to a stationary (intermediate) IAB node and a scenario that the mobile IAB node directly connects to an IAB donor.

The following principles need to be respected.
The mobile IAB node needs to be able to provide a service to legacy UEs.
Solutions that provide optimization for a mobile IAB may require extended functions of UEs according to Rel-18, but are limited only to a case where such an extended function has backward compatibility.

One of the main tasks of Rel-18 is a method of efficiently executing handover on a plurality of descendant UEs during transition of the mobile IAB node. This supplementary note provides an initial discussion on mobility enhancement for a mobile IAB from a viewpoint of handover of the UE.

### 2. Discussion

### 2.1 Group Reconfiguration

Group UE mobility is expected to be one of the possible enhancement measures for the mobile IAB. This is because, when the mobile IAB node moves to a new IAB donor, many UEs need to be handed over simultaneously.

According to the current specification, handover is indicated by dedicated signaling, i.e. RRC reconfiguration and synchronization. This means that a plurality of individual messages are simultaneously transmitted to respective UEs. Accordingly, a group reconfiguration may be considered as a candidate for reducing a signaling overhead and delay. Thus, it is expected to reconfigure a plurality of UEs by one message.

The group reconfiguration has already been discussed as a “common RRC structure” of the MBS according to Rel-17, and the following summary has been provided.

### Summary On Common RRC Structure

### Conclusion

Opinions that standardization of the common RRC configuration cannot be achieved are 16 to 5 and occupy the majority. From the reporter's point of view, there seems to be no technical restriction to suppress the standardization, but there seems to be a big opposition to standardize the RRC configuration. It is generally understood that adoption of the common RRC structure increases an overhead of a Uu signal, yet an F1/E1 signal has an advantage. However, considering standpoints of companies, it has been proposed to maintain the current RRC signal structure.

Proposal 2: A current CRRRC structure is maintained, and the common RRC structure is not advanced (i.e. there is no influence on RRCCR).

The point is that the UE needs to receive an individual RRC reconfiguration and, in addition, needs to receive a group RRC reconfiguration. Hence, there has been a common view that the MBS has little advantage (a disadvantage instead) for the Uu signal, but the F1/E1 signal may have some advantages. As a result, RAN2 has determined to maintain the current structure. That is, only the individual RRC reconfiguration is performed.

In a case of P2, RAN2 assumes that RRC continues to use a dedicated UE configuration if an agreement is reached.

The same/similar concerns apply to the mobile IAB. That is, different UEs have different configurations, and the different configurations of the different UEs cannot be processed by one group reconfiguration. The mobile IAB is also more useful than the MBS to reduce an F1 signal. However, the backhaul link is generally assumed on FR2, and therefore it is still important to reduce signals in an access link.

WID explicitly describes “the discussion on Rel-17 has already been made, and the solution needs to be avoided except for improvement specialized in mobility of IAB nodes so as not to touch points whose topics have been excluded from Rel-17”, and therefore RAN2 does not need to reopen the group reconfiguration (or common RRC structure) in the mobile IAB according to Rel-18, which is true at least from the viewpoint of RAN2.

Proposal 1: RAN2 needs to agree to use only an individual RRC reconfiguration as it is for handover of the UE performed as the mobile IAB node moves.

### 2.2 Handover for Legacy UEs

As indicated in Work Item Description (WID), “the mobile IAB node needs to support the legacy UEs”, and therefore RAN2 needs to study a handover method for the legacy UEs.

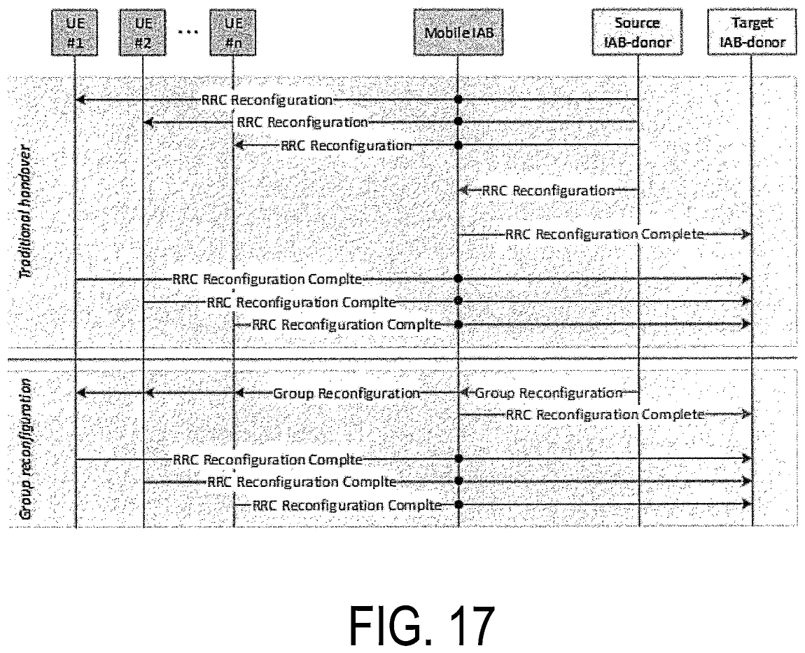

RAN3 has had two solutions for reduction of service interruption during transition of inter-donor IAB nodes according to Rel-17. The solution 1 of these solutions is illustrated in FIG. 17.

According to the solution 1, the IAB-DU suspends the RRCReconfiguration message to a child node at a time of completion of handover. RAN2 has concluded that both of the solutions need further discussion, yet determined that the solution 1 causes a less overall influence than the solution 2.

Naturally, handover of the UE can be also executed without the solution 1. In this regard, similar to a problem of the IAB node according to Rel-17, handover of a descendant UE is involved. Therefore, when the solution 1 is not applied, the UE experiences service interruption during transition of the moving IAB node. Accordingly, RAN2 needs to assume that the solution 1 for intra-donor transition is reused to reduce service interruption of the legacy UEs during transition of the inter-donor mobile IAB node.

Proposal 2: RAN2 needs to assume that the solution 1 for reducing the service interruption during transition of the intra-donor IAB node according to Rel-17 can be reused for handover of the legacy UEs.

### 2.3 Conditional Reconfiguration

When the individual RRC reconfigurations are simultaneously transmitted to UEs, a load of radio resources may increase due to many RRC messages and responses associated with the RRC messages. The conditional reconfiguration is considered useful for load balancing, that is, balancing in the time domain. This is to enable the IAB donor to avoid simultaneous transmission of many messages from the IAB node by reconfiguring the moving IAB node in advance. The solution 2 for reduction of service interruption according to Rel-17 has a similar solution.

Observation 1: The conditional reconfiguration may help the IAB donor balance RRCReconfiguration messages in the time domain.

Depending on how the mobile IAB-DU processes a cell, and in part due to determination of RAN3, it may be necessary for the mobile IAB-DU to change a cell ID after transition of the mobile IAB node. This is, for example, a case where changes are necessary to avoid PCI collision at a target topology. In this case, although the UE also needs to move from an old cell (a cell that disappears) to a new cell (a cell that becomes available), both of the cells are managed by the same mobile IAB-DU. For such “cell shift”, the conditional reconfiguration is considered more effective than conventional HO commands.

Observation 2: When a serving cell ID is changed due to transition of the mobile IAB node, the conditional reconfiguration may efficiently function.

Taking the above examples (but the examples are not limited thereto) into account, improvement of the conditional reconfiguration may be worth discussion for RAN2. Examples of the discussion include studying whether an existing trigger condition can be reused for the mobile IAB.

Proposal 3: RAN2 needs to study whether the conditional reconfiguration to the UE can be enhanced for improvement of mobility of the mobile IAB node.

### 2.4 RACH-Less Handover

According to the current specification, the UE needs to first start a random access procedure when receiving an HO command. In this regard, when the target cell is the same as the source cell, that is, when the same IAB-DU processes both of the cells, only cell IDs may be different. In this case, since timing advance value is also the same between both of the cells, PRACH transmission is unnecessary. RAN2 needs to study whether to specify RACH-less handover for improvement of mobility of the mobile IAB. Since RACH-less handover is applied only to UEs according to Rel-18, attention is necessary.

Proposal 4: RAN2 needs to study whether RACH-less handover of the UEs according to Rel-18 performed as the mobile IAB node moves is useful.

### 2.5 Lossless Handover

A problem of packet loss due to hop-by-hop ARQ has been discussed at a study phase. This problem is observed “when an IAB topology is changed after a failure of a hop-by-hop haul link or when inter-CU handover occurs”. According to Rel-16/17, this problem is a rare case in the assumption of deployment using stationary (still) IAB nodes, and therefore has not been pursued.

According to the mobile IAB according to Rel-18, when the mobile IAB node is an access IAB node at all times, such packet loss is still considered as a rare case. The justified part of WID describes the assumption that “the mobile IAB node does not have a descendant IAB node, that is, the mobile IAB node is serving only a UE”. Accordingly, this assumption needs to be confirmed by RAN2.

Proposal 5: RAN2 needs to confirm that the mobile IAB node is the access IAB node at all times, and packet loss due to hop-by-hop ARQ is a rare case in the mobile IAB according to Rel-18.

As for general packet loss, even legacy handover enables a PDCP sublayer of the UE to perform processing of recovering data in the same manner as and/or a similar manner to the current manner. Hence, improvement for lossless handover of the UE performed as the mobile IAB node moves is not scheduled.

Proposal 6: RAN2 needs to agree that the data recovery of the PDCP of the existing UE can be used for lossless handover performed as the mobile IAB node moves, that is. improvement is not necessary.

### 2.6 Other Aspects

WID describes that the mobile IAB node supports only UEs.
The mobile IAB node does not have child nodes, that is, the mobile IAB node needs to support only UEs.

To ensure this restriction, existing IAB support IEs can be reused. That is, the mobile IAB node does not configure this IE by an SIB1 to suppress access of other IAB nodes and permit the access of the UEs. The problem is how such a restriction is described in the specification. An explicit description in the specification of Stage-2 may help to avoid confusion at a time of implementation of the mobile IAB.

Proposal 7: RAN2 needs to agree to describe in the specification of Stage-2 that the IAB node does not configure an IAB support IE in an SIB when functioning as a mobile IAB node in this release.

1. A communication control method used in a cellular communication system, the communication control method comprising:
transmitting, at a base station, to a user equipment, a conditional reconfiguration that allows setting of Random Access Channel (RACH)-less handover for each target cell.

2. The communication control method according to claim 1,
wherein the base station is a donor node, and the user equipment is a user equipment subordinate to a mobile relay node.

3. The communication control method according to claim 2, further comprising:
transmitting, at the mobile relay node, to the donor node, combination information representing combinations of cells to which connection by the RACH-less handover is possible,
wherein the transmitting the conditional reconfiguration includes transmitting, at the base station, the conditional reconfiguration based on the combination information.

4. The communication control method according to claim 3,
wherein the transmitting the combination information incudes transmitting, at the mobile relay node, a timing advance value of each of the combinations.

5. A base station in a cellular communication system, the base station comprising a transceiver circuitry and a processing circuitry with the transceiver circuitry and configured to execute processing of:
transmitting, to a user equipment, a conditional reconfiguration that allows setting of Random Access Channel (RACH)-less handover for each target cell.

6. A user equipment in a cellular communication system, the user equipment comprising a transceiver circuitry and a processing circuitry with the transceiver circuitry and configured to execute processing of:
receiving, from a base station, a conditional reconfiguration that allows setting of Random Access Channel (RACH)-less handover for each target cell, and
performing the RACH-less handover according to the conditional reconfiguration.

7. A cellular communication system comprising:
a user equipment; and
a base station, wherein
the base station is configured to transmit, to the user equipment, a conditional reconfiguration that allows setting of Random Access Channel (RACH)-less handover for each target cell, and
the user equipment is configured to receive the conditional reconfiguration.

8. A non-transitory computer-readable storage medium storing a program for causing a computer of a base station in a mobile communication system to execute processing comprising:
transmitting, to a user equipment, a conditional reconfiguration that allows setting of Random Access Channel (RACH)-less handover for each target cell.

9. A chipset for a base station, the chipset comprising:
transmitting, to a user equipment, a conditional reconfiguration that allows setting of Random Access Channel (RACH)-less handover for each target cell.
